(19) United States
(12) Patent Application Publication
(10) Pub. No.: US 2017/0169759 A1
(43) Pub. Date: Jun. 15, 2017

(54) ELECTRONIC DEVICE HAVING FLEXIBLE DISPLAY AND METHOD FOR CONTROLLING THE SAME

(71) Applicant: Samsung Electronics Co., Ltd., Gyeonggi-do (KR)

(72) Inventor: Jongwoon JANG, Gyeongsangbuk-do (KR)

(73) Assignee: Samsung Electronics Co., Ltd.

(21) Appl. No.: 15/375,504

(22) Filed: Dec. 12, 2016

(30) Foreign Application Priority Data
Dec. 14, 2015 (KR) 10-2015-0178258

(51) Int. Cl. G09G 3/20; G09G 5/38; G09G 5/10; G06F 1/16

(52) U.S. Cl. CPC G09G 3/2096; G06F 1/1652; G09G 5/38; G09G 5/10; G09G 2320/0626; G09G 2320/0686; G09G 2354/00; G09G 2330/027; G09G 2340/045; G09G 2320/0242

(57) ABSTRACT

Provided are an electronic device having a flexible display and a method for controlling the same. The electronic device includes a flexible display and a processor that confirms a user's location with respect to the electronic device using a sensor that is functionally connected to the processor, determines a partial region of a display region of the flexible display based on the user's location, and controls luminance of the partial region.

### PRIORITY

This application claims priority under 35 U.S.C. §119(a) to Korean Patent Application No. 10-2015-0178258, which was filed in the Korean Intellectual Property Office on Dec. 14, 2015, the contents of which are incorporated herein by reference.

### BACKGROUND OF THE INVENTION

1. Field of the Disclosure

The present disclosure generally relates to an electronic device having a flexible display and a method for controlling the same.

2. Description of the Related Art

An electronic device, for example, a smart phone, a tablet personnel computer (PC), a notebook computer, a monitor, or a television receiver, has been used in various fields. Recently, an electronic device has been developed in various types including not only a device that is carried by a user (e.g., tablet PC or smart phone) but also a wearable device that can be worn or transplanted on a part of a user's body, such as an electronic watch (e.g., smart watch), a head-mounted display (HMD) (e.g., electronic glasses), electronic clothes, or electronic tattoo.

In general, an electronic device includes a flat display. The flat display may be generally classified into an emissive display and a non-emissive display. The emissive display may include an organic light emitting display (OLED), a plasma display panel (PDP), a flat cathode ray tube (FCRT), a vacuum fluorescent display panel (VFD), or a light emitting diode (LED) panel. The non-emissive display may include a liquid crystal display (LCD) panel.

Further, use of electronic devices that include a curved display or a flexible display has recently increased. Such electronic devices provide visual information (e.g., image or moving image) through the curved display or the flexible display. For example, the electronic device may provide visual information to a user through an unflexed region or a flexed region of the curved display or the flexible display.

However, when visual information is provided through the curved or flexible display, a user has different viewpoints between an unflexed region and a flexed region of the curved or flexible display. For example, an area of the flexed region that is recognized by the user may be smaller than an actual area of the flexed region. Accordingly, the user may perceive that the unflexed region and the flexed region have different display attributes (e.g., luminance and color sense). For example, even if the overall region of the curved or flexible display has the same luminance, the user may perceive that the luminance of the flexed region is lower than the luminance of the unflexed region of the curved or flexible display.

### SUMMARY

The present disclosure has been made to address at least the above-mentioned problems and/or disadvantages and to provide at least the advantages described below.

Accordingly, an aspect of the present disclosure controls display attributes of a partial region (e.g., flexed region) of a curved or flexible display based on a user's location, so that a user is made to recognize as if the overall region of the curved or flexible display has the same display attributes.

Another aspect of the present disclosure controls display attributes of a flexed region of a curved or flexible display based on a user's location and a degree of flex of the flexed region, to allow a user to recognize the display as if the overall region of the curved or flexible display has the same display attributes as when the flexible display is not curved.

Another aspect of the present disclosure turns off a partial region of a curved or flexible display in the case where the partial region is flexed over a specific angle based on a user's location and a user is unable to see an image that is displayed on the flexed region.

In accordance with an aspect of the present disclosure, an electronic device includes a flexible display and a processor, which confirms a user's location with respect to the electronic device using a sensor that is functionally connected to the processor, determines a partial region of a display region of the flexible display at least based on the user's location, and controls luminance of at least the partial region.

In accordance with another aspect of the present disclosure, a method is provided for controlling an electronic device having a flexible display that includes displaying an image on the flexible device; confirming a user's location with respect to the electronic device when displaying the image; determining a partial region of a display region of the flexible display based on the confirmed user's location; and controlling luminance of the partial region.

In accordance with another aspect of the present disclosure, a computer readable recording medium is provided that stores therein a program for executing displaying an image on a flexible display of the electronic device; confirming a user's location with respect to the electronic device using a sensor that is functionally connected to a processor when displaying the image; determining a partial region of a display region of the flexible display based on the user's location; and controlling luminance of the partial region.

### BRIEF DESCRIPTION OF THE DRAWINGS

The above and other aspects, functions, and advantages of certain embodiments of the present disclosure will be more apparent from the following detailed description taken in conjunction with the accompanying drawings, in which:

FIG. 1 is a block diagram illustrating a network environment including an electronic device according to an embodiment of the present disclosure;

FIG. 2 is a block diagram of an electronic device according to an embodiment of the present disclosure;

FIG. 3 is a block diagram of a programming module according to an embodiment of the present disclosure;

FIG. 4 is a block diagram illustrating an electronic device according to an embodiment of the present disclosure;

FIG. 5 is a diagram illustrating a display unit including a sensor according to an embodiment of the present disclosure;

FIG. 6 is a diagram explaining luminance control of a flexible display that is flexed in a first direction according to an embodiment of the present disclosure;

FIG. 7 is a diagram explaining luminance control of a flexible display that is flexed in a second direction according to an embodiment of the present disclosure;

FIG. 8 is a diagram explaining luminance control of a flexible display in accordance with a user's location according to an embodiment of the present disclosure;

FIG. 9 is a flowchart explaining a method for controlling the display attributes of an electronic device based on a user's location according to an embodiment of the present disclosure; and

FIG. 10 is a flowchart explaining a method for controlling the display attributes of an electronic device based on a user's location and an angle of flexion according to an embodiment of the present disclosure.

### DETAILED DESCRIPTION OF EMBODIMENTS OF THE PRESENT DISCLOSURE

The following description with reference to the accompanying drawings is provided to assist in a comprehensive understanding of various embodiments of the present disclosure. It includes various details to assist in that understanding but these are to be regarded as merely examples. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in describing the following description and claims are not limited to their dictionary meanings, but are merely used to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly indicates otherwise. Thus, for example, reference to “a component surface” includes reference to one or more of such surfaces.

In this disclosure, the expressions “A or B” or “at least one of A and/or B” may include A, may include B, or may include both A and B. Expressions including ordinal numbers, such as “first” and “second,” etc., may modify various elements. However, the above expressions do not limit the sequence and/or importance of the elements and are used merely for the purpose to distinguish an element from the other elements.

Where a certain (e.g., the first) element is referred to as being “connected” or “accessed” (functionally or communicatively) to other (e.g., the second) element, it should be understood that the element is connected or accessed directly to the other element or through another (e.g., the third) element.

In this disclosure, the expression “configured to” may be used, depending on situations, interchangeably with “adapted to”, “having the ability to”, “modified to”, “made to”, “capable of”, or “designed to”. In some situations, the expression “device configured to” may mean that the device may operate with other device(s) or other component(s). For example, the expression “processor configured to perform A, B and C” may mean a dedicated processor (e.g., an embedded processor) for performing the above operations, or a general-purpose processor (e.g., central processing unit (CPU) or an application processor (AP)) capable of performing the above operations by executing one or more software programs stored in a memory device.

An electronic device of this disclosure may include at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), a Moving Picture Experts Group phase 1 or phase 2 (MPEG-1 or MPEG-2) audio layer 3 (MP3) player, a medical device, a camera, and a wearable device, or the like. For example, a wearable device may include at least one of an accessory type (e.g., a watch, a ring, a bracelet, an anklet, a necklace, an electronic accessory, eyeglasses, contact lenses, or a head-mounted device (HMD)), a textile or cloth assembled type (e.g., electronic clothing), a body attached type (e.g., a skin pad or tattoo), and a body transplant circuit. An electronic device may include at least one of a television (TV), a digital versatile disc (DVD) player, an audio device, a refrigerator, an air-conditioner, a vacuum cleaner, an oven, a microwave, a washing machine, an air cleaner, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, and an electronic frame, or the like.

An electronic device may include at least one of various medical devices (e.g., magnetic resonance angiography (MRA), magnetic resonance imaging (MRI), computed tomography (CT), a scanning machine, an ultrasonic wave device, etc.), a navigation device, a global navigation satellite system (GNSS), an event data recorder (EDR), a flight data recorder (FDR), a vehicle infotainment device, an electronic equipment for a ship (e.g., navigation equipment for a ship, gyrocompass, etc.), avionics, a security device, a head unit or device for a vehicle, an industrial or home robot, a drone, an automated teller machine (ATM), a point of sales (POS), and various Internet of things (IoT) devices (e.g., a lamp, various sensors, a sprinkler, a fire alarm, a thermostat, a street light, a toaster, athletic equipment, a hot water tank, a heater, a boiler, etc.), or the like.

An electronic device may include at least one of furniture, a portion of a building/structure or car, an electronic board, an electronic signature receiving device, a projector, and various measuring meters (e.g., a water meter, an electric meter, a gas meter, a wave meter, etc.), or the like. An electronic device may be flexible or a combination of two or more of the aforementioned devices. The electronic device is not limited to the aforementioned devices. In this disclosure, the term a user may refer to a person who uses an electronic device, or a machine (e.g., an artificial intelligence device) which uses an electronic device.

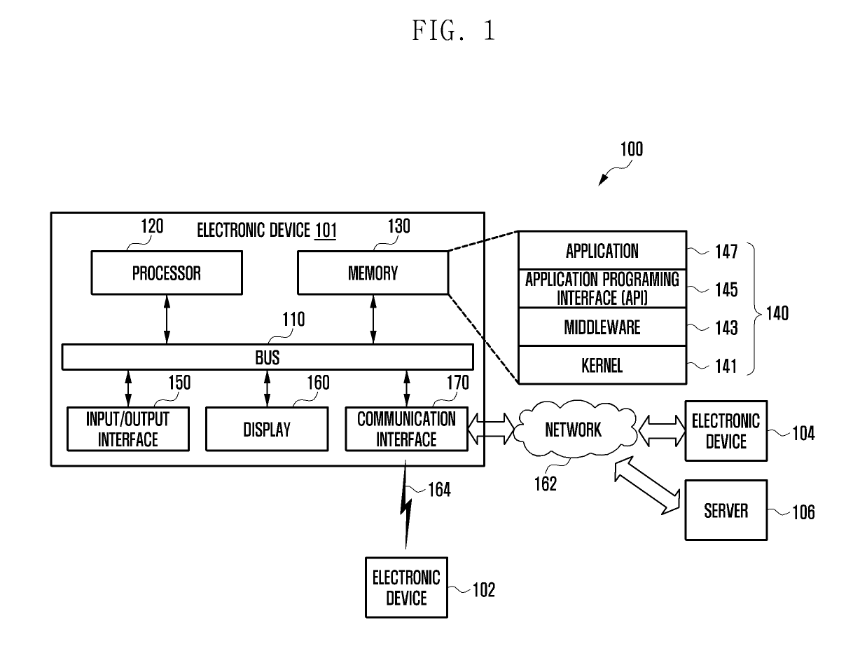

FIG. 1 is a block diagram illustrating a network environment 100 including an electronic device 101 in accordance an embodiment of the present disclosure.

Referring to FIG. 1, the electronic device 101 includes, but is not limited to, a bus 110, a processor 120, a memory 130, an input/output interface 150, a display 160, and a communication interface 170. The bus 110 may be a circuit designed for connecting the above-discussed elements and communicating data (e.g., a control message) between such elements. The processor 120 may receive commands from the other elements (e.g., the memory 130, the input/output interface 150, the display 160, or the communication interface 170, etc.) through the bus 110, interpret the received commands, and perform the arithmetic or data processing based on the interpreted commands. The memory 130 may store therein commands or data received from or created at the processor 120 or other elements (e.g., the input/output interface 150, the display 160, or the communication interface 170, etc.). The memory 130 may include programming modules 140 such as a kernel 141, a middleware 143, an application programming interface (API) 145, and an application 147. Each of the programming modules may be composed of software, firmware, hardware, and any combination thereof.

The kernel 141, as illustrated in FIG. 1, may control or manage system resources (e.g., the bus 110, the processor 120, the memory 130, etc.) used to execute operations or functions implemented by other programming modules (e.g., the middleware 143, the API 145, and the application 147). Also, the kernel 141 may provide an interface capable of accessing and controlling or managing the individual elements of the electronic device 101 by using the middleware 143, the API 145, or the application 147.

The middleware 143 may serve to go between the API 145 or the application 147 and the kernel 141 in such a manner that the API 145 or the application 147 communicates with the kernel 141 and exchanges data therewith. Also, in relation to work requests received from one or more applications and/or the middleware 143, for example, may perform load balancing of the work requests by using a method of assigning a priority, in which system resources (e.g., the bus 110, the processor 120, the memory 130, etc.) of the electronic device 101 can be used, to at least one of the one or more applications. The API 145 is an interface through which the application 147 is capable of controlling a function provided by the kernel 141 or the middleware 143, and may include, for example, at least one interface or function for file control, window control, image processing, character control, or the like. The input/output interface 150 may deliver commands or data, entered by a user through an input/output unit or device (e.g., a sensor, a keyboard, or a touch screen), to the processor 120, the memory 130, or the communication interface 170 via the bus 110.

The display 160 may include, for example, a liquid crystal display (LCD), a light emitting diode (LED) display, an organic LED (OLED) display, a micro electro mechanical system (MEMS) display, or an electronic paper display, or the like. The display 160 may display various types of contents (e.g., text, images, videos, icons, or symbols) for users. The display 160 may include a touch screen, and may receive, for example, a touch, gesture, proximity, or hovering input by using an electronic device or a part of the user's body.

The communication interface 170 may establish communication between the electronic device 101 and any external device (e.g., the first external electronic device 102, the second external electronic device 104, or the server 106) using various communication circuitry. For example, the communication interface 170 may be connected with a network 162 through wired or wireless communication 164 and thereby communicate with any external device (e.g., the second external electronic device 104, or the server 106).

Wireless communication may use, as cellular communication protocol, at least one of long-term evolution (LTE), LTE advanced (LTE-A), code division multiple access (CDMA), wideband CDMA (WCDMA), universal mobile telecommunications system (UMTS), wireless broadband (WiBro), global system for mobile communications (GSM), and the like, for example. A short-range communication may include, for example, at least one of Wi-Fi, Bluetooth (BT), near field communication (NFC), magnetic secure transmission or near field magnetic data stripe transmission (MST), and GNSS, and the like. The GNSS may include at least one of, for example, a global positioning system (GPS), a global navigation satellite system (GLONASS), a BeiDou navigation satellite system (BeiDou), and Galileo, the European global satellite-based navigation system. Hereinafter, the “GPS” may be interchangeably used with the “GNSS” in the present disclosure.

The wired communication includes, but is not limited to, at least one of universal serial bus (USB), high definition multimedia interface (HDMI), recommended standard 232 port (RS-232), or plain old telephone service (POTS). The network 162 includes, as a telecommunications network at least one of a computer network (e.g., local area network (LAN) or wide area network (WAN)), the internet, and a telephone network. The types of the first and second external electronic devices 102 and 104 may be the same as or different from the type of the electronic device 101. The server 106 may include a group of one or more servers. A portion or all of operations performed in the electronic device 101 may be performed in one or more other electronic devices 102 or 104 or the server 106. In the case where the electronic device 101 performs a certain function or service automatically or in response to a request, the electronic device 101 may request at least a portion of functions related to the function or service from another electronic device 102 or 104 or the server 106 instead of or in addition to performing the function or service for itself. The other electronic device 102 or 104, or the server 106 may perform the requested function or additional function, and may transfer a result of the performance to the electronic device 101. The electronic device 101 may additionally process the received result to provide the requested function or service. To this end, for example, a cloud computing technology, a distributed computing technology, or a client-server computing technology may be used.

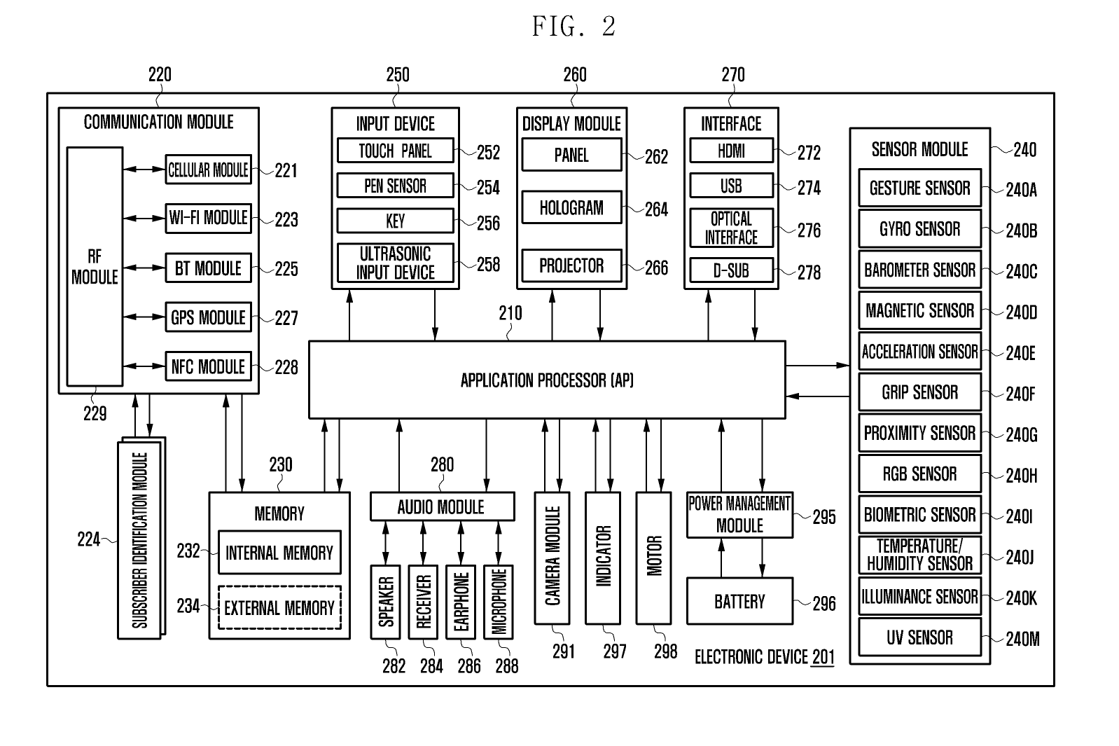

FIG. 2 is a block diagram of an electronic device 201 according to an embodiment of the present disclosure. The electronic device 201 may form, for example, the whole or part of the electronic device 101 shown in FIG. 1.

Referring to FIG. 2, the electronic device 201 may include at least one AP 210, a communication module (e.g., including communication circuitry) 220, a subscriber identification module (SIM) card 224, a memory 230, a sensor module (e.g., including various sensors) 240, an input unit or input device (e.g., including input circuitry) 250, a display or display module 260, an interface (e.g., including interface circuitry) 270, an audio module 280, a camera module 291, a power management module 295, a battery 296, an indicator 297, and a motor 298. The AP 210 is capable of driving, for example, an operating system or an application program to control a plurality of hardware or software components connected to the AP 210, processing various data, and performing operations. The AP 210 may be implemented as, for example, a system on chip (SoC). The AP 210 may further include a graphics processing unit (GPU) and/or an image signal processor.

The AP 210 may also include at least part of the components shown in FIG. 2, e.g., a cellular module 221. The AP 210 is capable of loading commands or data received from at least one of other components (e.g., a non-volatile memory) on a volatile memory, processing the loaded commands or data. The AP 210 is capable of storing various data in a non-volatile memory. The communication module 220 (e.g., the communication interface 170) may include various communication circuitry configured to perform a data communication with any other electronic device (e.g., the electronic device 104 or the server 106) connected to the electronic device 201 (e.g., the electronic device 101) through the network. The communication module 220 may include therein the cellular module 221, a Wi-Fi module 223, a BT module 225, a GNSS or GPS module 227, an NFC module 228, and a radio frequency (RF) module 229. The cellular module 221 is capable of providing a voice call, a video call, a short message service (SMS), an internet service, etc., through a communication network, for example. The cellular module 221 is capable of identifying and authenticating an electronic device 201 in a communication network by using the SIM card 224. The cellular module 221 is capable of performing at least part of the functions provided by the AP 210. The cellular module 221 is also capable of including a communication processor (CP).

As illustrated in FIG. 2, the Wi-Fi module 223, the BT module 225, the GNSS or GPS module 227, and the NFC module 228 are each capable of including a processor for processing data transmitted or received through the corresponding module.

The NFC module 228 is capable of including a processor for processing data transmitted or received through the corresponding module. At least part of the cellular module 221, Wi-Fi module 223, BT module 225, GNSS or GPS module 227, NFC module 228, and NFC module (e.g., two or more modules) may be included in one integrated chip (IC) or one IC package. The RF module 229 is capable of transmission/reception of communication signals, e.g., RF signals. The RF module 229 is capable of including a transceiver, a power amp module (PAM), a frequency filter, a low noise amplifier (LNA), an antenna, etc. At least one of the cellular module 221, the Wi-Fi module 223, the BT module 225, the GNSS or GPS module 227, and the NFC module 228 is capable of transmission/reception of RF signals through a separate RF module.

The SIM card 224 is a card including a SIM and/or an embodied SIM. The SIM module card 224 is also capable of containing unique identification information, e.g., integrated circuit card identifier (ICCID), or subscriber information, e.g., international mobile subscriber identity (IMSI).

As illustrated in FIG. 2, memory 230 (e.g., memory 103 shown in FIG. 1) is capable of including a built-in or internal memory 232 and/or an external memory 234. The built-in or internal memory 232 is capable of including at least one of the following: a volatile memory, e.g., a dynamic random access memory (DRAM), a static RAM (SRAM), a synchronous dynamic RAM (SDRAM), etc.; and a non-volatile memory, e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, an NOR flash memory, etc.), a hard drive, a solid state drive (SSD), etc.

The memory 230 stores instructions which are executable by the AP 210 to configure the processor to receive a gesture input made through the touch panel 252, detect touch coordinates corresponding to the gesture input, determine predictive coordinates corresponding to the touch coordinates, determine whether to compensate the predictive coordinates based on the movement direction of the gesture input, determine target coordinates corresponding to the predictive coordinates based on the movement speed of the gesture input, and display at least one object at the target coordinates on the display.

The memory 230 stores instructions executable by the AP 210 to configure the processor to detect touch coordinates corresponding to a gesture input on the touch panel.

The memory 230 stores instructions executable by the AP 210 to configure the processor to check the movement direction of the gesture input at first touch coordinates at a first time point and the movement direction of the gesture input at second touch coordinates at a second time point.

The memory 230 stores instructions executable by the AP 210 to configure the processor to compare the movement direction checked at the first touch coordinates and the movement direction checked at the second touch coordinates.

The memory 230 stores instructions executable by the AP 210 to configure the processor to determine, when the movement direction of the gesture input at the second touch coordinates differs from the movement direction of the gesture input at the first touch coordinates, the difference between the first touch coordinates and first predictive coordinates corresponding thereto and compensate the second predictive coordinates corresponding to the second touch coordinates for the difference.

The memory 230 stores instructions executable by the AP 210 to configure the processor to maintain, when the movement direction of the gesture input at the second touch coordinates is identical with the movement direction of the gesture input at the first touch coordinates, the second predictive coordinates corresponding to the second touch coordinates.

The memory 230 stores an instruction executable by the AP 210 to configure the processor to check movement speed of the gesture input at the detected touch coordinates.

The memory 230 stores an instruction executable by the AP 210 to configure the processor to determine, when the movement speed is equal to or greater than a predetermined value, the predictive coordinates as target coordinates.

The memory 230 stores an instruction executable by the AP 210 to configure the processor to determine, when the movement speed is less than the predetermined value, target coordinates corresponding to the predictive coordinates.

The sensor module 240 includes various sensors capable of measuring/detecting a physical quantity or an operation state of the electronic device 201, and converting the measured or detected information into an electronic signal. The sensor module 240 is capable of including at least one of a gesture sensor 240A, a gyro sensor 240B, an atmospheric pressure or barometer sensor 240C, a magnetic sensor 240D, an acceleration sensor 240E, a grip sensor 240F, a proximity sensor 240G, a color or RGB sensor 240H (e.g., a red, green and blue (RGB) sensor), a biometric sensor 240I, a temperature/humidity sensor 240J, an illuminance sensor 240K, and an ultraviolet (UV) sensor 240M.

Additionally or alternatively, the sensor module 240 is capable of further including one or more of the following sensors and operations that include an electronic nose (E-nose) sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 is capable of further including a control circuit for controlling one or more sensors included therein.

The electronic device 201 can include a processor, configured as part of the AP 210 or a separate component, for controlling the sensor module 240. In this case, while the AP 210 is operating in a sleep mode, the processor is capable of controlling the sensor module 240. The input device 250 is capable of including the touch panel 252, a (digital) pen sensor (digital pen or stylus) 254, a key 256, or an ultrasonic input unit or device 258. The touch panel 252 may be implemented with at least one of the following: a capacitive touch system, a resistive touch system, an infrared touch system, and an ultrasonic touch system. The touch panel 252 may further include a control circuit. The touch panel 252 may also further include a tactile layer to provide a tactile response to the user. The (digital) pen sensor 254 may be implemented with a part of the touch panel or with a separate recognition sheet. The key 256 may include a physical button, an optical key, or a keypad. The ultrasonic input unit 258 is capable of detecting ultrasonic waves, created in an input tool, through a microphone 288, and identifying data corresponding to the detected ultrasonic waves.

The display module 260 (e.g., the display 106 shown in FIG. 1) is capable of including a panel 262, a hologram unit 264, or a projector 266. The panel 262 may include the same or similar configurations as the display 106 shown in FIG. 1. The panel 262 may be implemented to be flexible, transparent, or wearable.

The panel 262 may also be incorporated into one module together with the touch panel 252. The hologram unit 264 is capable of showing a stereoscopic image in the air by using light interference. The projector 266 is capable of displaying an image by projecting light onto a screen. The screen may be located inside or outside of the electronic device 201. The display module 260 further includes a control circuit for controlling one or more of the panel 262, the hologram unit 264, and the projector 266.

The interface 270 is capable of including an HDMI 272, a USB 274, an optical interface 276, or a D-subminiature (D-sub) 278. The interface 270 may be included in the communication interface 107 shown in FIG. 1. Additionally or alternatively, the interface 270 is capable of including a mobile high-definition link (MHL) interface, an SD card/MMC interface, or an infrared data association (IrDA) standard interface.

The audio module 280, as illustrated in FIG. 2, can provide bidirectional conversion between a sound and an electronic signal. At least part of the components in the audio module 280 may be included in the input/output interface 145 shown in FIG. 1. The audio module 280 is also capable of processing sound information input or output through a speaker 282, a receiver 284, earphones 286, microphone 288, etc.

The camera module 291 refers to a device capable of taking both still and moving images. The camera module 291 is capable of including one or more image sensors (e.g., a front image sensor or a rear image sensor), a lens, an image signal processor (ISP), a flash (e.g., an LED or xenon lamp), etc.

The power management module 295 manages power of the electronic device 201. The power management module 295 is capable of including a power management IC (PMIC), a charger IC, or a battery gauge. The PMIC may employ wired charging and/or wireless charging methods. Examples of the wireless charging method are magnetic resonance charging, magnetic induction charging, and electromagnetic charging. To this end, the PMIC may further include an additional circuit for wireless charging, such as a coil loop, a resonance circuit, a rectifier, etc. The battery gauge is capable of measuring the residual capacity, charge in voltage, current, or temperature of the battery 296. The battery 296 takes the form of either a rechargeable battery or a solar battery.

The indicator 297 displays a specific status of the electronic device 201 or a part thereof (e.g., the AP 210), e.g., a boot-up status, a message status, a charging status, etc. The motor 298 is capable of converting an electrical signal into mechanical vibrations, such as, a vibration effect, a haptic effect, etc. The electronic device 201 is capable of further including a processing unit (e.g., GPU) for supporting a mobile TV. The processing unit for supporting a mobile TV is capable of processing media data pursuant to standards, e.g., digital multimedia broadcasting (DMB), digital video broadcasting (DVB), or MediaFlo™, etc.

Each of the elements described in the present disclosure may be formed with one or more components, and the names of the corresponding elements may vary according to the type of the electronic device. The electronic device may include at least one of the above described elements described in the present disclosure, and may exclude some of the elements or further include other additional elements. Further, some of the elements of the electronic device may be coupled to form a single entity while performing the same functions as those of the corresponding elements before the coupling.

The touch input processing method of the electronic device 201 may include receiving a gesture input made through the touch panel, detecting touch coordinates corresponding to the gesture input on the touch panel, determining predictive coordinates corresponding to the touch coordinates, determining whether to compensate the predictive coordinates based on the movement direction of the gesture input, determining target coordinates corresponding to the predictive coordinates based on the movement speed of the gesture input, and displaying at least one object at the target coordinates on the display.

The touch input processing method of the electronic device 201 includes detecting the touch coordinates of the gesture input at a predetermined time interval.

The touch input processing method of the electronic device 201 includes checking the movement direction of the gesture input at first touch coordinates at a first time point and checking the movement direction of the gesture input at second coordinates at a second time point.

The touch input processing method of the electronic device 201 includes comparing the movement direction of the gesture input at the first touch coordinates and the movement direction of the gesture input at the second touch coordinates.

The touch input processing method of the electronic device 201 includes determining, when the movement direction of the gesture input at the second touch coordinates is different from the direction of the gesture input at the first touch coordinates, difference between the first touch coordinates and the first predictive coordinates corresponding thereto, and compensating the second predictive coordinates corresponding to the second touch coordinates for the difference.

The touch input processing method of the electronic device 201 includes maintaining, when the movement direction of the gesture input at the second touch coordinate is substantially identical with the direction of the gesture input at the first touch coordinates, the second predictive coordinates corresponding to the second touch coordinates.

The touch input processing method of the electronic device 201 includes checking movement speed of the gesture input at the detected touch coordinates.

The touch input processing method of the electronic device includes determining, when the movement speed is equal to or greater than a predetermined value, the predictive coordinates as target coordinates.

The touch input processing method of the electronic device 201 includes determining, when the movement speed is less than the predetermined value, target coordinates corresponding to the predictive coordinates.

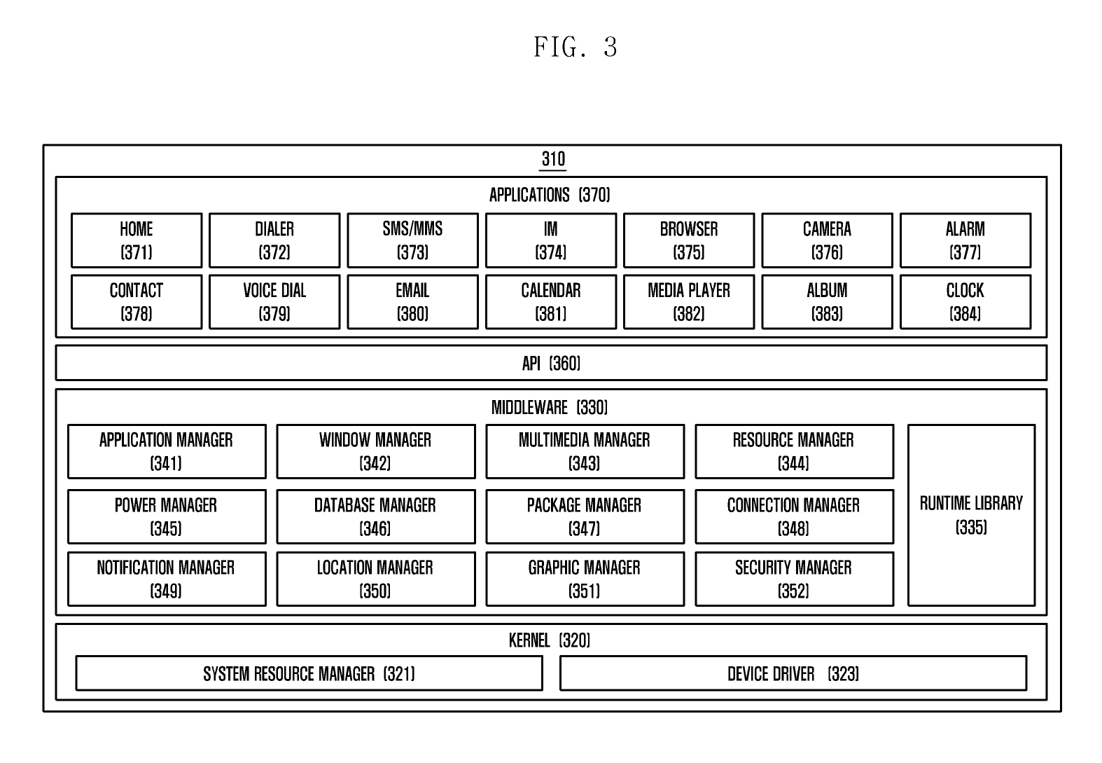

FIG. 3 is a block diagram of a programming module 310 according to an embodiment of the present disclosure.

The programming module 310 may be included (e.g., stored) in the electronic device 100 (e.g., the memory 130) illustrated in FIG. 1, or may be included (e.g., stored) in the electronic device 201 (e.g., the memory 230) illustrated in FIG. 2. At least a part of the programming module 310 may be implemented in software, firmware, hardware, or a combination of two or more thereof. The programming module 310 may be implemented in hardware (e.g., the hardware 200 of FIG. 2), and may include an operating system (OS) controlling resources related to an electronic device (e.g., the electronic device 100) and/or various applications (e.g., an application 370) executed in the OS. For example, the OS may be Android, iOS, Windows, Symbian, Tizen, Bada, and the like.

Referring to FIG. 3, the programming module 310 may include a kernel 320, a middleware 330, an API 360, and/or the application 370.

The kernel 320 (e.g., the kernel 141 in FIG. 1) may include a system resource manager 321 and/or a device driver 323. The system resource manager 321 may include, for example, a process manager, a memory manager, and a file system manager. The system resource manager 321 may perform the control, allocation, recovery, and/or the like of system resources. The device driver 323 may include, for example, a display driver, a camera driver, a BT driver, a shared memory driver, a USB driver, a keypad driver, a Wi-Fi driver, and/or an audio driver. Also, the device driver 312 may include an inter-process communication (IPC) driver.

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity or connection manager 348, a notification manager 349, a location manager 350, a graphic manager 351, a security manager 352, and any other suitable and/or similar manager(s).

The runtime library 335 may include, for example, a library module used by a compiler, in order to add a new function by using a programming language during the execution of the application(s) 370. The runtime library 335 may perform functions which are related to input and output, the management of a memory, an arithmetic function, and/or the like.

The application manager 341 may manage, for example, a life cycle of at least one of the applications 370. The window manager 342 may manage graphical user interface (GUI) resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345, as illustrated in FIG. 3, may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity or connection manager 348 may manage a wireless connectivity such as, for example, Wi-Fi and BT. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. When the electronic device has a telephone function, the middleware 330 further includes a telephony manager for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some elements, may further include other elements, or may replace the some of the elements with elements, each of which performs a similar function and has a different name.

The API 360 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 147) may include, for example, a preloaded application and/or a third party application. The applications 370 (e.g., the applications 134) may include, for example, a home application 371, a dialer application 372, an SMS/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application(s), e.g., the application 147.

At least a part of the programming module 310 may be implemented by instructions stored in a non-transitory computer-readable storage medium. When the instructions are executed by one or more processors (e.g., AP 210), the one or more processors may perform functions corresponding to the instructions. The non-transitory computer-readable storage medium may be, for example, the memory 230. At least a part of the programming module 310 may be implemented (e.g., executed) by, for example, AP 210. At least a part of the programming module 310 may include, for example, a module, a program, a routine, a set of instructions, and/or a process for performing one or more functions.

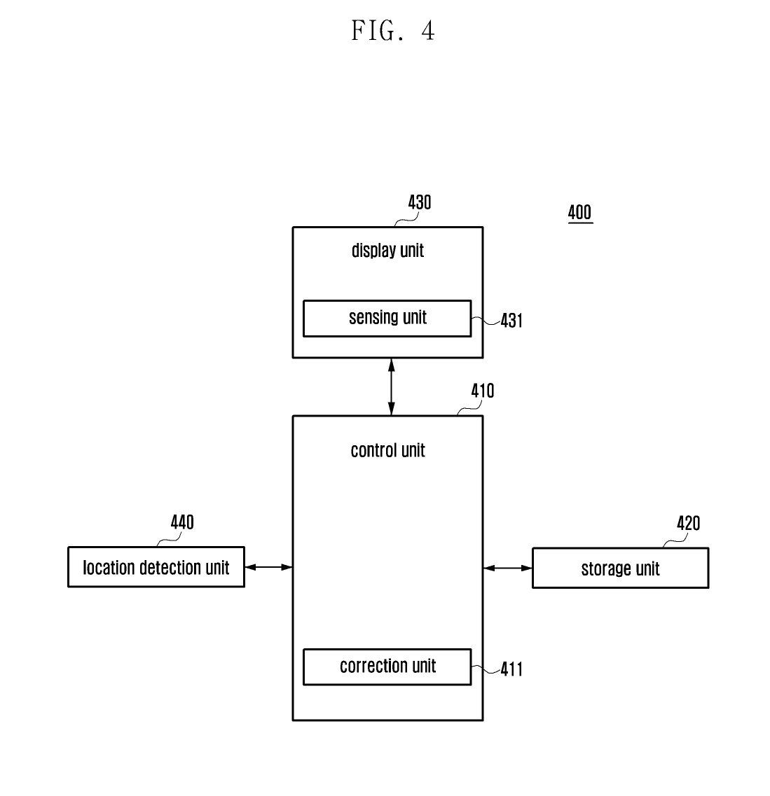

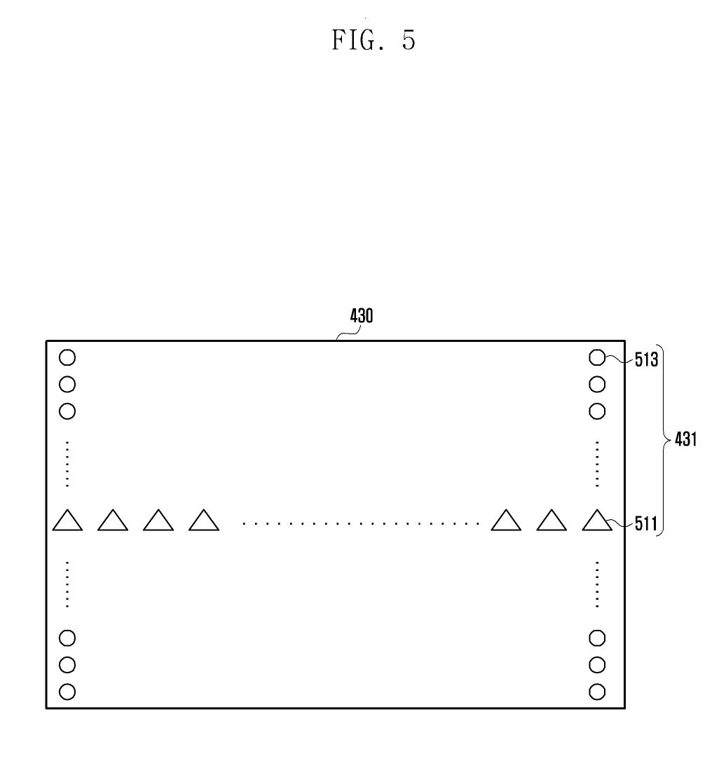

FIG. 4 is a block diagram illustrating an electronic device according to an embodiment of the present disclosure. FIG. 5 is a diagram illustrating a display unit including a sensor according to an embodiment of the present disclosure.

Referring to FIGS. 4 and 5, an electronic device 400 may include a control unit 410, a storage unit 420, a display unit 430, and a location detection unit 440. The display unit 430 (e.g., display 160 or display module 260) is a curved or flexible display device. The control unit 410 (e.g., processor 120 of FIG. 1 or AP 210 of FIG. 2) may control the overall operation of the electronic device 400 and signal flow between internal blocks of the electronic device 400, and may perform data processing function for processing data. For example, the control unit 410 may be composed of processors, for example, a CPU, an application processor, and a communication processor. The control unit 410 may be composed of a single-core processor or a multi-core processor. Further, the control unit 410 may be composed of plural processors.

The control unit 410 may transmit image data to the display unit 430 to display the image data thereon. The control unit 410 may determine at least a partial region of the display unit 430 based on a user's location, and may control display attributes (e.g., luminance and color sense) of at least the partial region as determined above. At least the partial region may be a region, on which luminance or color sense may be differently seen by a user, of a display region of the display unit 430 according to the user's location. The user's location is based on the relative concept, and changes as the user moves when the electronic device 400 is fixed. In contrast, the user's location may be change as the electronic device moves when the user does not move.

The control unit 410 controls the display attributes based on the user's location and a degree of flex, i.e., flexion, of the display unit 430. For this, the control unit 410 may include a correction unit 411.

The correction unit 411 controls the display attributes based on the user's location. For example, the correction unit 411 may receive the user's location from the location detection unit 440, and may correct the display attributes of at least the partial region of the display unit 430 based on the user's location.

The correction unit 411 controls the display attributes on the basis of the user's location and the degree of flex of the display unit 430. For example, the correction unit 411 may receive the user's location from the location detection unit 440, and may receive a sensing value that corresponds to the degree of flex of the display unit 430 from a sensing unit 431. The correction unit 411 may determine at least the partial region in which correction of the display attributes is necessary on the basis of the received user's location and sensing value, and may determine a degree of correction of at least the partial region as determined above.

The control unit 410 may correct the image data to correspond to the determination of the correction unit 411, and may transmit the corrected image data to the display unit 430. Further, the control unit 410 may control the display attributes (e.g., luminance and color sense) through changing a voltage or current that is applied to a backlight of the display unit 430 or a unit pixel.

If correction of the display attributes is requested automatically or manually, the control unit 410 may confirm a region to be corrected, and may correct the display attributes of the confirmed region. For example, if the display unit 430 is activated, the control unit 410 may confirm whether to correct the display attributes for a predetermined period (e.g., for a predetermined time (10 seconds) or for predetermined frames (e.g., 200 frames), and if necessary, the control unit 410 may correct the display attributes.

Further, if flexing of the display unit 430 is sensed, the control unit 410 may control the display attributes of at least a partial region of the display unit 430. The display unit 430 may be flexed by a user or may be automatically flexed in accordance with the surrounding environment (e.g., illumination intensity or execution application).

The storage unit 420 may store the operating system (OS) of the electronic device 400 and application programs that are necessary for other optional functions, for example, audio reproduction, image or moving image reproduction, broadcast reproduction, Internet connection, text messaging, gaming, and road guide service. Further, the storage unit 420 may store various types of data, for example, music data, moving image data, game data, movie data, and map data.

The storage unit 420 may store a lookup table that defines the relationship between the user's location and correction values of the display attributes and/or a lookup table that defines the relationship among the user's location, the angle of flexion, and the correction values of the display attributes.

The display unit 430 displays various menus of the electronic device 400, information that is input by a user, and information to be provided to a user. The display unit 430 as described above may be a curved display or a flexible display. The display unit 430 may be a liquid crystal display, an organic light emitting diode (OLED), an active matrix organic light emitting diode (AMOLED), a field emission display, an electroluminescent display, or an electrophoretic display. Further, the display unit 430 may be formed of a transparent display.

The display unit 430 may include a touch panel, a display driver IC (DDI), a flexible printed circuit board (FPCB), a polarizing plate, and a window cover.

The display unit 430 may display various screens through using of the electronic device 400, for example, a home screen, a menu screen, a lock screen, a game screen, a web page screen, a call screen, and a music or moving image reproduction screen. The display attributes of at least a partial region of the display unit 430 may be controlled at least based on the user's location. Further, the display attributes of at least a partial region of the display unit 430 may be controlled further based on the flexion thereof.

The display unit 430 includes the sensing unit 431 that senses the bending movement, i.e., flexion. The sensing unit 431 measures the degree of flex of the display unit 430 and may transmit the result of measurement to the correction unit 411. For example, if the display unit 430 is flexed, the sensing unit 431 confirms a reference region and a flexed region, and may measure the degree (e.g., angle) of flex between the confirmed reference region and the flexed region. The reference region may be, for example, a region that corresponds to a user (e.g., user's gaze) with respect to the display unit 430. The flexed region may be, for example, a region that is flexed over a designated angle against the reference region.

The sensing unit 431 may be a flex sensor or a force sensor. The sensing unit 431 confirms the location and the degree of flex of the display unit 430 using resistance values or electrical values that are sensed through one or more flex sensors or force sensors that are functionally connected to the display unit 430. The flex sensor may be, for example, a sensor that senses the resistance value that is changed in accordance with the degree of flex of the display unit 430, and the force sensor may be, for example, a sensor that converts a physical force into an electrical signal.

The sensing unit 431 includes at least one first sensor 511 for measuring the location and the degree of flex in a horizontal direction and at least one second sensor 513 for measuring the location and the degree of flex in a vertical direction. For example, as illustrated in FIG. 5, the sensing unit 431 includes at least one first sensor 511 and at least one second sensor 513 which are arranged in multiple rows and multiple columns. The type, the number, and the arrangement location of the first sensor 511 and the second sensor 513 may differ in accordance with the production characteristics.

When the display unit 430 includes a plurality of flex sensors (or force sensors) that are arranged in different locations of the display unit 430, the sensing unit 431 may sense respective resistance values (or electrical values) of the plurality of flex sensors (or force sensors) that are arranged in different locations. If the changed resistance values (or electrical values) of the plurality of flex sensors (or force sensors) correspond to a designated range (e.g., predetermined changed values), the sensing unit 431 determines that the location of the display unit 430, which corresponds to the flex sensors (or force sensors) having the resistance values (or electrical values) that belong to the designated range, is flexed, and recognizes the degree of flex in accordance with the resistance values (or electrical values).

As described above, the flex sensor or the force sensor is an example of a sensor that senses the flexed location and the degree of flex of the display unit 430. However, the sensor that can sense the location and the degree of flex of the display unit 430 is not limited thereto, but may be implemented by various types of sensors.

The display unit 430 may be manually flexed by a user. Further, the display unit 430 may be automatically flexed based on the surrounding situation (e.g., illumination intensity or application being executed). For example, at least a part of the display unit 430 may be automatically flexed based on the surrounding illumination intensity of the electronic device 400. For example, the shape of the display unit 430 may be changed to a cylindrical shape based on low illumination intensity (e.g., about 10 lux). Further, the shape of the display unit 430 may be changed to a planar shape based on high illumination intensity (e.g., about 100 lux).

The degree of flex of the display unit 430 may differ corresponding to the illumination intensity. For example, the degree of flex of the display unit 430 becomes higher as the illumination intensity becomes lower, and if the illumination intensity falls below a predetermined value (e.g., about 10 lux), the shape of the display unit 430 may be changed to the cylindrical shape. In contrast, the degree of flex of the display unit 430 having the cylindrical shape is reduced as the illumination intensity becomes higher, and if illumination intensity exceeds a predetermined value (e.g., about 100 lux), the shape of the display unit 430 changes to the planar shape.

The degree of flex may be automatically determined based on an application that is executed by the electronic device 400. For example, if an email application is executed, the display unit 430 may be flexed at a designated angle (e.g., 90°) to be divided into two parts (e.g., a keyboard output screen and an email output screen). Further, if a watch application is executed, the shape of the display unit 430 may be changed to a cylindrical shape so that it can be wound on a user's wrist.

If at least a part of the display unit 430 is flexed automatically or by a user, the display unit 430 maintains the changed (flexed) shape.

The location detection unit 440 may be a sensor for detecting the user's location. The location detection unit 440 transmits the user's location to the correction unit 411. The location detection unit 440 may include an infrared sensor and a camera. For example, if the location detection unit 440 is a camera, it may recognize a face from a preview image, and may confirm whether the user's face is located in the center of the image or on the left or right side of the image. The location detection unit 440 may transmit the confirmed user's location to the correction unit 411.

The sensing unit 431 may be included in the display unit 430 or may be separately configured.

When not included in the control unit 410, the correction unit 411 may be separately configured or may be included in the display unit 430.

The location detection unit 440 may be included in the display unit 430.

On the other hand, the electronic device 400 may further selectively include constituent elements, such as a broadcast receiving module for receiving broadcasts, a digital sound source reproduction module such as an MP3 module, a short-range communication module, and various sensor modules such as illumination sensor module. Further, the electronic device 400 may include constituent elements having the same level as the above-described constituent elements.

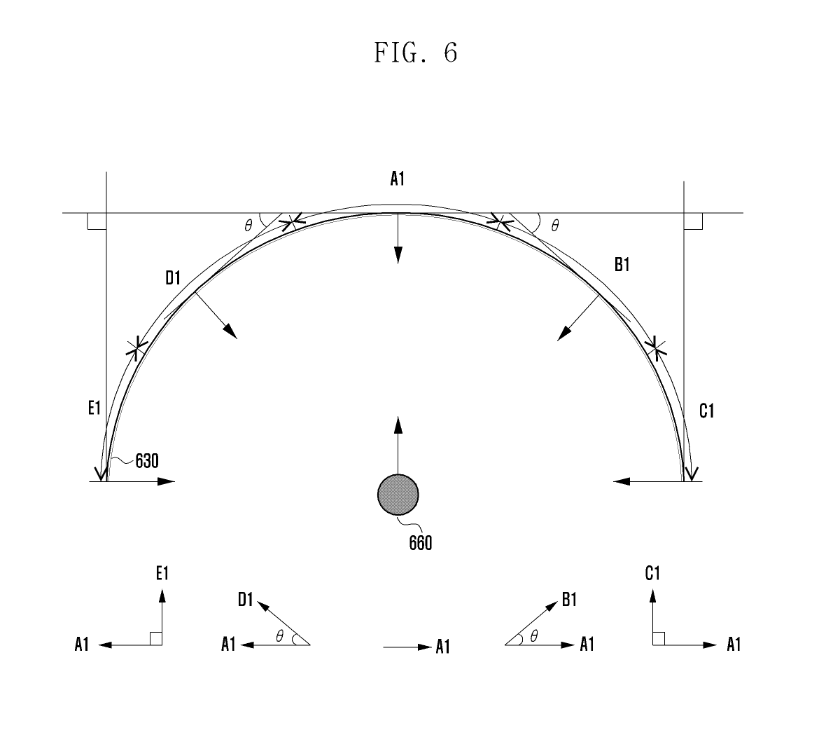

Hereinafter, an example of correcting luminance of a flexible display is provided referring to FIGS. 6 to 8, for convenience in explanation.

FIG. 6 is a diagram explaining luminance control of a flexible display that is flexed in a first direction according to an embodiment of the present disclosure.

Referring to FIG. 6, a flexible display 630 may be flexed toward a user 660. The surface of a region A1 that the user 660 is seeing forms an angle of about 90° with the user's gaze. The region A1 becomes a reference region for correcting the luminance of the flexible display 630. The reference region may be set as a region that forms a predetermined angle range (e.g., 85° to 95°) with the user's gaze.

On the other hand, a region B1 may form an angle of θ with the region A1, and a region C1 may form a right angle with the region A1. The degree of flex increases going from the region A1 to the region C1. In this case, the electronic device maintains the luminance of the region A1 of the flexible display 630, increases the luminance of the region B1 as high as a first level, and increases the luminance of the region C1 as high as a second level. The first level is a level at which the user can perceive that the luminance of the region B1 and the luminance of the region A1 are equal to each other, and the second level is a level at which the user can perceive that the luminance of the region C1 and the luminance of the region A1 are equal to each other. Here, the second level may be higher than the first level.

If it is assumed that the left and right sides of the flexible display 630 are equally flexed based on the center of the flexible display 630, a region D1 forms an angle of θ with the region A1, and a region E1 forms a right angle with the region A1. The electronic device increases the luminance of the region D1 of the flexible display 630 to the first level, and increases the luminance of the region E1 to the second level.

On the other hand, referring to FIG. 6, it is described that the luminance is corrected with respect to two regions on the left and right sides, without the present disclosure being limited thereto. For example, there may be three or more regions of which the luminance is corrected.

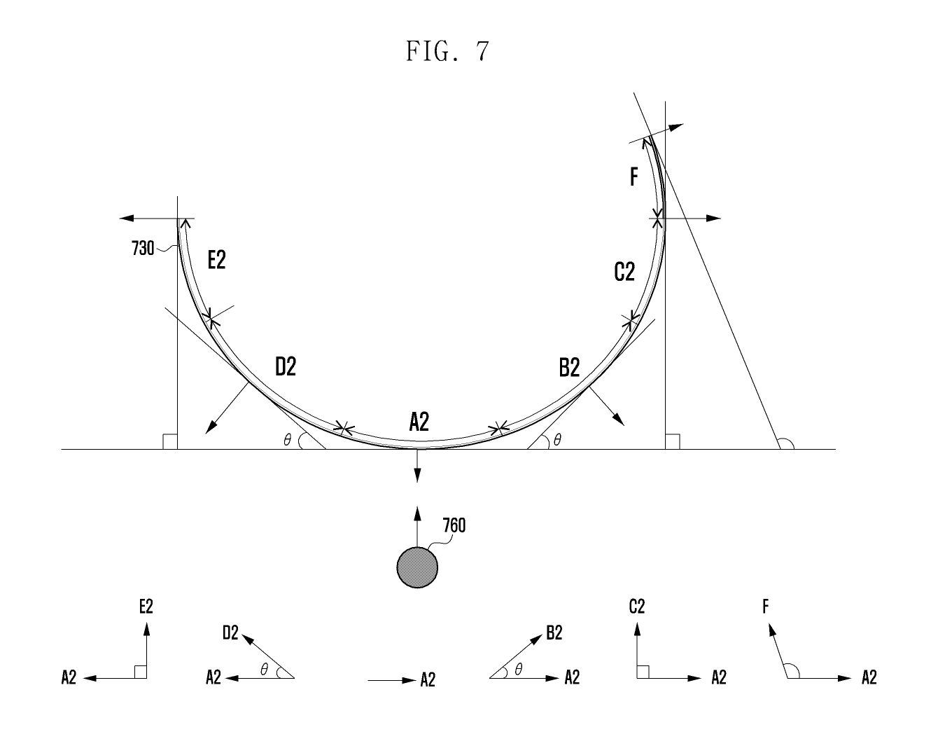

FIG. 7 is a diagram explaining luminance control of a flexible display that is flexed in a second direction according to an embodiment of the present disclosure.

Referring to FIG. 7, a flexible display 730 is flexed toward an opposite side of a user 760. The surface of a region A2 viewed by the user 760 forms an angle of about 90° with user's gaze. The region A2 becomes a reference region for correcting the luminance of the flexible display 730.

On the other hand, a region B2 forms an angle of θ with the region A2, and a region C2 forms a right angle with the region A2. The degree of flex increases going from the region A2 to the region C2. In this case, the electronic device maintains the luminance of the region A2 of the flexible display 730, increases the luminance of the region B2 as high as a first level, and increases the luminance of the region C2 as high as a second level. Here, the second level is higher than the first level.

If it is assumed that the left and right sides of the flexible display 730 are equally flexed based on the center of the flexible display 730, a region D2 forms an angle of θ with the region A2, and a region E2 forms a right angle with the region A2. The electronic device increases the luminance of the region D2 of the flexible display 730 to the first level, and increases the luminance of the region E2 to the second level.

On the other hand, a region F that is flexed to exceed 90° based on the region A is not seen by the user. Accordingly, the electronic device turns off the region F. At least a partial region that has a non-visible range that is not visible to the user is turned off, and thus unnecessary power consumption is prevented. If the region F is turned off, the electronic device reduces the size of an image so that the image that is being displayed on an area that is measured from the region A2 to the region F can be displayed on an area that is measured from the region A2 to the region E2.

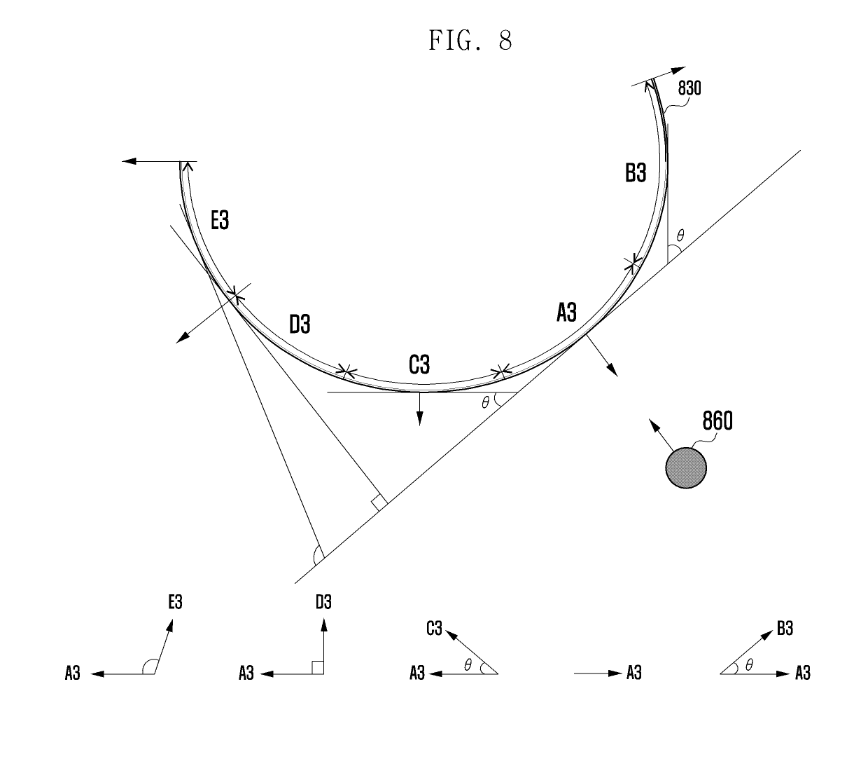

FIG. 8 is a diagram explaining luminance control of a flexible display in accordance with a user's location according to an embodiment of the present disclosure.

Referring to FIG. 8, a flexible display 830 may be flexed toward an opposite side of the user 860. The user 860 is located on the right side of the flexible display 830 rather than the center of the flexible display 830.

As the location of the user 860 is changed, a region A3 that the user 860 is viewing is a reference region. The electronic device maintains the luminance of the region A3, increases the luminance of the regions B3 and C3 as high as a first level, increases the luminance of the region D3 as high as a second level, and turns off a region E3. Accordingly, correction is provided of the luminance of at least a partial region of the flexible display 830 based on the location of the user 860 and the flexion of the flexible display 830.

An electronic device (e.g., electronic device 101 of FIG. 1, electronic device 201 of FIG. 2, or electronic device 400 of FIG. 4) may include a flexible display (e.g., display 160 of FIG. 1, display module 260 of FIG. 2, or display 430 of FIG. 4), and a processor (e.g., processor 120 of FIG. 1, AP 210 of FIG. 2, or processor 410 of FIG. 4), wherein the processor confirms a user's location with respect to the electronic device using a sensor that is functionally connected to the processor, determines at least a partial region of a display region of the flexible display at least based on the user's location, and controls luminance of at least the partial region.

The electronic device further includes a storage unit that stores a lookup table that defines a relationship between the user's location and a luminance correction value.

The processor determines the partial region of which the luminance is to be corrected based on the user's location, extract the luminance correction value from the lookup table, and controls the luminance of the determined partial region based on the extracted luminance correction value.

The processor senses flexion of the display region, divides the display region into at least a first region and a second region in accordance with the flexion, and selects one of the first region and the second region as the partial region further based on the flexion.

The processor controls luminance of a region in which a flexion angle according to the flexion has a first range as a first designated luminance, and controls luminance of a region in which the flexion angle has a second range as a second designated luminance.

The processor turns off the partial region of the flexible display in which a flexion angle according to the flexion of the display region is included in a non-visible range that a user is unable to see.

The processor reduces and displays an image so that the flexion angle corresponds to the partial region of the flexible display that is included in a visible range that the user is able to see when the partial region of the flexible display that is included in the non-visible range is turned off.

The processor controls the luminance of at least the partial region through changing a voltage or current that is applied to a backlight or a unit pixel of the flexible display.

The processor corrects color sense of an image that is displayed on at least the partial region of the display region based on the user's location and the degree of flex of the display region.

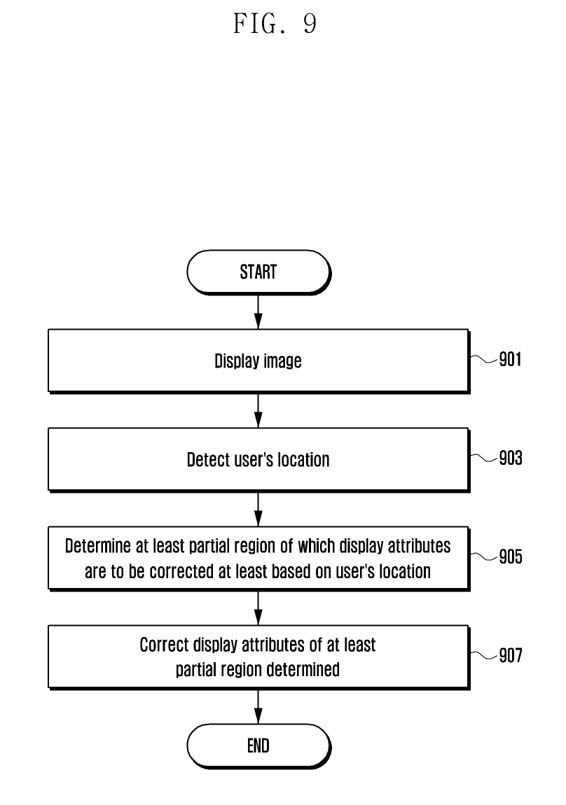

FIG. 9 is a flowchart explaining a method for controlling the display attributes of an electronic device based on a user's location according to an embodiment of the present disclosure.

Referring to FIG. 9, at step 901, a processor (e.g., processor 120 of FIG. 1, AP 210 of FIG. 2, or processor 410 of FIG. 4) of an electronic device (e.g., electronic device 101 of FIG. 1, electronic device 201 of FIG. 2, or electronic device 400 of FIG. 4) may display an image. For example, if a flexible display (e.g., display 160 of FIG. 1, display module 260 of FIG. 2, or display 430 of FIG. 4) is turned on, the electronic device may display an image. For example, the image is not limited to a specific type, and includes various types of data that can be output through the flexible display. For example, the image may be a still image including characters, symbols or signs, texts, icons, or an image, a moving image, or a three-dimensional (3D) image.

At step 903, the processor of the electronic device confirms a user's location. For example, the electronic device may confirm the user's location with respect to the electronic device using at least one sensor that is functionally connected to the processor. The user's location is based on the relative concept, and changes as the user moves when the electronic device is fixed, or changes as the electronic device moves when the user does not move.

At step 905, the processor of the electronic device determines at least a partial region of a display region of the flexible display at least based on the detected user's location. For example, the electronic device may determine at least the partial region of the display region, of which the display attributes are to be controlled, at least based on the detected user's location. The display attributes include luminance and/or color sense.

A region other than at least the partial region may be set as a reference region in which control of the display attributes is not necessary. For example, the reference region may be a partial region of the display region that corresponds to a direction in which the user is sensed, and may be a flat region in which the curvature is within a designated range (e.g., about 5°).

The processor of the electronic device determines the reference region based on user information. The user information includes, for example, user's gaze information or face information. For example, the electronic device may acquire user's gaze direction (or face direction) through an image sensor that is functionally connected to the processor. The processor of the electronic device may determine at least a partial region of the display region that corresponds to the user's gaze direction as the reference region.

On the other hand, a device for acquiring the user information is not limited to the image sensor.

At step 907, the processor of the electronic device controls, i.e., adjusts, the display attributes of at least the partial region as determined above. For example, the processor of the electronic device may control the luminance of at least the partial region based on the user's location.

The luminance of at least the partial region may be controlled through various methods using hardware or software. For example, the electronic device can control the luminance of the partial region by correcting at least a part of data (e.g., data indicating luminance and/or color) that corresponds to an image displayed on the flexible display using software. Further, the electronic device can control the luminance of the partial region by adjusting a voltage or current that is supplied to a backlight or a unit pixel.

On the other hand, if movement of the user's location is sensed, the processor of the electronic device may return to step 903 to repeat the above-described process. On the other hand, if the image display is ended, for example, if the flexible display is turned off, the processor of the electronic device may end the procedure for controlling the display attributes.

On the other hand, although the display attributes of at least a part of the display region are controlled, i.e., adjusted, based on the user's location, the present disclosure is not so limited and includes, for example, a user interface that can be changed in accordance with the user's location. For example, when the partial region of the flexible display is flexed beyond a predetermined angle (e.g., 90°) and the user is unable to see the region, the electronic device may reduce the display an image on a partial region within the predetermined angle. Further, if the flexible display is flexed to divide the flexible display into plural regions in a state where plural applications are being executed, the electronic device displays the plural applications on the respective regions.

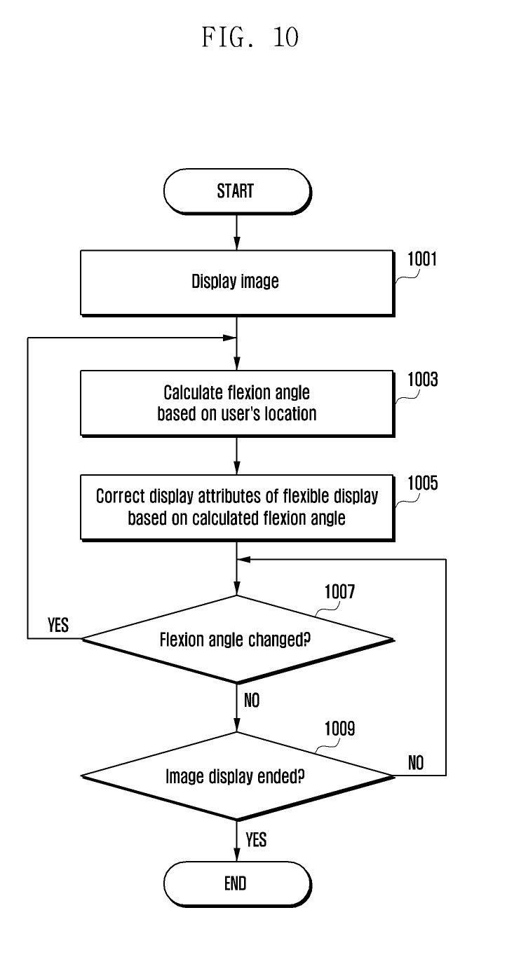

FIG. 10 is a flowchart explaining a method for controlling the display attributes of an electronic device based on a user's location and an angle of flexion according to an embodiment of the present disclosure.

Referring to FIG. 10, at step 1001, a processor (e.g., processor 120 of FIG. 1, AP 210 of FIG. 2, or processor 410 of FIG. 4) of an electronic device (e.g., electronic device 101 of FIG. 1, electronic device 201 of FIG. 2, or electronic device 400 of FIG. 4) may display an image. For example, if a flexible display (e.g., display 160 of FIG. 1, display module 260 of FIG. 2, or display 430 of FIG. 4) is turned on, the electronic device may display a still image, a moving image, or a 3D image.

At step 1003, the processor of the electronic device calculates the degree of flex, i.e., the flexion angle, of the flexible display based on the location of the user of the electronic device. For example, the processor of the electronic device confirms the user's location, and determines a reference region that corresponds to the user's location. Further, the processor of the electronic device determines the reference region based on user information (gaze direction or face direction). If the reference region is determined, the processor of the electronic device calculates a flexion angle of another region with respect to the reference region through a flexion sensor. For example, the processor of the electronic device may calculate the flexion angle of the other region with respect to at least one of a horizontal direction and a vertical direction.

The flexible display may be manually flexed by a user. Further, the flexible display may be automatically flexed based on the surrounding situation (illumination intensity or execution application). For example, the shape of the flexible display may be automatically changed (e.g., at least a part of the flexible display may be flexed) based on the surrounding illumination intensity of the electronic device. For example, the shape of the flexible display may be changed to a cylindrical shape based on low surrounding illumination intensity (e.g., about 10 lux) of the electronic device. Further, the shape of the flexible display may be changed to a planar shape based on high surrounding illumination intensity (e.g., about 100 lux) of the electronic device. The degree of flex of the flexible display may differ corresponding to the illumination intensity. For example, the degree of flex of the flexible display increases as the illumination intensity becomes lower, and if the illumination intensity becomes below a predetermined value (e.g., about 10 lux), the shape of the flexible display may be changed to the cylindrical shape. In contrast, the degree of flex of the flexible display having the cylindrical shape decreases as the illumination intensity increases, and if illumination intensity becomes over a predetermined value (e.g., about 100 lux), the shape of the flexible display may be changed to the planar shape.

The degree of flex may be automatically determined based on an application that is executed by the electronic device. For example, if an email application is executed in the electronic device, the electronic device may control the flexible display to be flexed at a designated angle (e.g., 90°) so as to divide the screen into two parts (e.g., a keyboard output screen and an email output screen). Further, if a watch application is executed in the electronic device, the electronic device may change the shape of the flexible display to a cylindrical shape so that the flexible display can be wound on the user's wrist.

If at least a part of the flexible display is flexed automatically or by the user, the electronic device maintains the changed (flexed) shape of the flexible display.

At step 1005, the processor of the electronic device corrects the display attributes (e.g., luminance) of the flexible display based on the calculated flexion angle. For example, the processor of the electronic device may correct the luminance of at least a partial region (e.g., the other region) of the flexible display based on the calculated flexion angle. For example, the processor of the electronic device may maintain the luminance of a region (reference region) having the flexion angle of about 0°. Further, the processor of the electronic device may increase the luminance of a region of which the flexion angle is within a visible range that a user can see (e.g., a region having the flexion angle that exceeds 0° and less than 90° and a region having the flexion angle that exceeds −90° and less than 0°).

The processor of the electronic device divides the region that is within the visible range into plural flexion regions, and controls the display attributes (e.g., luminance) for the respective flexion regions. For example, the processor of the electronic device may set a region having the flexion angle that is greater than or equal to −5° and is less than or equal to 5° as a reference region, and may set a region having the flexion angle that is greater than or equal to −40° and is less than −5°, or a region having the flexion angle that exceeds 5° and is less than or equal to 40°, as a first flexion region. Further, the processor of the electronic device may set a region having the flexion angle that is greater than or equal to −75° and is less than −40°, or a region having the flexion angle that exceeds 40° and is less than or equal to 75° as a second flexion region, and may set a region having the flexion angle that is greater than or equal to −90° and is less than −75°, or a region having the flexion angle that exceeds 75° and is less than or equal to 90°, as a third flexion region.

The processor of the electronic device may control the luminance for each flexion region. For example, the processor of the electronic device may control the luminance of the first flexion region as a first designated luminance, control the luminance of the second flexion region as a second designated luminance, and control the luminance of the third flexion region as a third designated luminance.

On the other hand, the present disclosure is not limited to a case where the region is divided into three flexion regions to control the display attributes. For example, the display attributes can be controlled by dividing a partial region of the flexible display that is within the first range into two or four or more flexion regions.

The processor of the electronic device may turn off a partial region of the flexible display having the flexion angle that is within a non-visible range (e.g., that is greater than or equal to 90° and is less than 270°).

If the partial region of the flexible display having the non-visible range is turned off, the processor of the electronic device controls (e.g., reduces) and display a resized image corresponding to the size of an activation region (e.g., region in a visible range) that is not turned off.

At step 1007, the processor of the electronic device may confirm whether the calculated flexion angle is changed. For example, the processor of the electronic device may confirm whether at least one of the user's location, the degree of flex of the flexible display, and the flexed region is changed.

If the calculated flexion angle is changed, the processor of the electronic device returns to the step 1003 to repeat the above-described process. In contrast, if the calculated flexion angle is not changed, at step 1009, the processor of the electronic device may confirm whether image display is ended. For example, the processor of the electronic device may confirm whether the flexible display is turned off.

If the flexible display is not turned off, the processor of the electronic device may return to the operation 1007. In contrast, if the flexible display is turned off, the processor of the electronic device may end the display attribute control (adjustment) procedure.

A method for controlling an electronic device having a flexible display includes displaying an image; confirming a user's location with respect to the electronic device using a sensor that is functionally connected to a processor when displaying the image; determining at least a partial region of a display region of the flexible display at least based on the confirmed user's location; and controlling luminance of at least the partial region.

Determining at least the partial region includes detecting flexion of the display region and dividing the display region into at least a first region and a second region based on the detected flexion and determining one of the first region and the second region as the partial region further based on the flexion.

Controlling the luminance of at least the partial region includes controlling luminance of a region in which a flexion angle according to the flexion has a first range as a first designated luminance and controlling luminance of a region in which the flexion angle has a second range as a second designated luminance.

Controlling the luminance of at least the partial region further includes determining a reference region that corresponds to the confirmed user's location and maintaining luminance of the reference region.

The method further includes turning off the partial region of the flexible display in which a flexion angle according to the flexion of the display region is included in a non-visible range that a user is unable to see.

The method further includes reducing and displaying an image so that the flexion angle corresponds to the partial region of the flexible display that is included in a visible range that the user is able to see when the partial region of the flexible display that is included in the non-visible range is turned off.

Detecting the flexion of the display region includes detecting the flexion in at least one of a horizontal direction and a vertical direction of the flexible display.

Controlling the luminance of at least the partial region includes determining the partial region of which the luminance is to be corrected based on the user's location; extracting a luminance correction value from the lookup table that defines the relationship among the user's location, the degree of flex, and the luminance correction value; and controlling the luminance of the determined partial region based on the extracted luminance correction value.

Controlling the luminance of at least the partial region includes controlling the luminance of at least the partial region through changing a voltage or current that is applied to a backlight or a unit pixel of the flexible display.

The method further includes correcting color sense of an image that is displayed on at least the partial region of the display region corresponding to the user's location and the degree of flex of the display region.

Accordingly, a problem of non-uniformity of the display attributes, which may occur due to the user's location or the flexion of the curved or flexible display, is solved, and a partial region (non-visible region) of the curved or flexible display, which is flexed over a specific angle and is unable to be seen by a user, is turned off, thereby preventing unnecessary power consumption.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), circuitry and a programmable-logic device for performing certain operations which have been known or are to be developed in the future.

Examples of computer-readable media include magnetic media, such as hard disks, floppy disks, and magnetic tape; optical media such as compact disc ROM (CD-ROM) and DVD; magneto-optical media, such as floptical disks; and hardware devices that are specially configured to store and perform program instructions (e.g., programming modules), such as ROM, RAM, flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules include one or more components, remove part of them described above, or include new components. The operations performed by modules, programming modules, or the other components, according to the present disclosure, may be executed in serial, parallel, repetitive or heuristic fashion. Part of the operations can be executed in any other order, skipped, or executed with additional operations.

It will be understood that the above-described embodiments are provided as examples to help easy understanding of the contents of the present disclosure and do not limit the scope of the present disclosure. Accordingly, the scope of the present disclosure is defined by the appended claims, and it will be construed that all corrections and modifications derived from the meanings and scope of the following claims and the equivalent concept fall within the scope of the present disclosure.

What is claimed is:

1. An electronic device comprising:
a flexible display; and
a processor configured to:
confirm a user's location with respect to the electronic device using a sensor that is functionally connected to the processor,
determine a partial region of a display region of the flexible display based on the user's location, and
control luminance of the partial region.

2. The electronic device of claim 1, further comprising a storage unit configured to store a lookup table that defines a relationship between the user's location and a luminance correction value.

3. The electronic device of claim 2, wherein the processor is further configured to:
determine the partial region of which the luminance that is to be corrected based on the user's location,
extract the luminance correction value from the lookup table, and
control the luminance of the determined partial region based on the extracted luminance correction value.

4. The electronic device of claim 1, wherein the processor is further configured to:
detect flex of the display region,
divide the display region into a first region and a second region based on the detected flex, and
select one of the first region and the second region as the partial region based on the detected flex.

5. The electronic device of claim 4, wherein the processor is further configured to control providing of a first designated luminance of a region in which a flexion angle of the detected flex has a first range, and control providing of a second designated luminance of a region in which the flexion angle has a second range.

6. The electronic device of claim 4, wherein the processor turns off the partial region of the display region of the flexible display in which a flexion angle of the detected flex of the display region is in a non-visible range that a user is unable to see.

7. The electronic device of claim 6, wherein the processor is further configured to reduce and display an image in a remaining region of the flexible display corresponding to a visible range that the user is able to see when the partial region of the flexible display in the non-visible range is turned off.

8. The electronic device of claim 1, wherein the processor is further configured to control the luminance of the partial region by changing one of a voltage and current that is applied to a backlight or at least one unit pixel of the flexible display.

9. The electronic device of claim 1, wherein the processor is further configured to correct a color sense of an image that is displayed on the partial region of the display region based on a user's location and a degree of flex of the display region.

10. A method for controlling an electronic device having a flexible display, the method comprising:
displaying an image on the flexible display;
confirming a user's location with respect to the electronic device when displaying the image;
determining a partial region of a display region of the flexible display based on the user's location; and
controlling luminance of the partial region.

11. The method of claim 10, wherein determining the partial region comprises:
detecting flex of the display region; and
dividing the display region into a first region and a second region based on the detected flex; and
selecting one of the first region and the second region as the partial region further based on the detected flex.

12. The method of claim 11, wherein controlling the luminance of the partial region comprises:
providing a first designated luminance of a region in which a flexion angle of the detected flex has a first range; and
providing a second designated luminance of a region in which the flexion angle has a second range.

13. The method of claim 12, wherein controlling the luminance of the partial region further comprises:
determining a reference region that corresponds to the user's location; and
maintaining luminance of the reference region.

14. The method of claim 11, further comprising turning off the partial region of the display region of the flexible display in which a flexion angle of the detected flex of the display region is in a non-visible range that a user is unable to see.

15. The method of claim 14, further comprising reducing and displaying an image in a remaining region of the flexible display corresponding to a visible range that the user is able to see when the partial region of the flexible display in the non-visible range is turned off.

16. The method of claim 11, wherein detecting the flex of the display region comprises detecting flex in at least one of a horizontal direction and a vertical direction of the flexible display.

17. The method of claim 10, wherein controlling the luminance of the partial region comprises:
determining a partial region of which the luminance is to be corrected based on the user's location;
extracting a luminance correction value from a lookup table that defines the relationship between the user's location, a degree of flex, and a luminance correction value; and
controlling the luminance of the determined partial region based on the extracted luminance correction value.

18. The method of claim 10, wherein controlling the luminance of the partial region comprises controlling the luminance of the partial region by changing one of a voltage and current applied to a backlight or at least one unit pixel of the flexible display.

19. The method of claim 11, further comprising correcting a color sense of an image that is displayed on the partial region of the display region corresponding to the user's location and a degree of flex of the display region.

20. A computer readable recording medium storing therein a program for controlling execution of:
displaying an image on a flexible display of an electronic device;
confirming a user's location with respect to the electronic device using a sensor that is functionally connected to a processor when displaying the image;
determining a partial region of a display region of the flexible display based on the user's location; and
controlling luminance of the partial region.
